(19) United States
(12) Patent Application Publication
(10) Pub. No.: US 2009/0307759 A1
(43) Pub. Date: Dec. 10, 2009

(54) Temporary Domain Membership for Content Sharing

(75) Inventors: Patrik Schnell, Issaquah, WA (US); James M. Alkove, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/134,360

(22) Filed: Jun. 6, 2008

(51) Int. Cl. G06F 21/00

(52) U.S. Cl. 726/4

(57) ABSTRACT

In accordance with one or more aspects, a first device receives a digital certificate of a second device. The first device generates a digitally signed temporary domain join request and sends the request to a domain controller. The domain controller generates, for the first device, a temporary domain certificate allowing the first device to temporarily consume content bound to the domain. The temporary domain certificate is sent to the first device, allowing the first device to temporarily consume content bound to the domain.

### BACKGROUND

Digital media playback devices such as portable music players, desktop and laptop computers, handheld computers or personal digital assistants (PDAs), cell phones, and so forth have become increasingly commonplace. These devices frequently employ digital rights management (DRM) techniques in order to protect the rights of the artists and/or copyright owners of digital content on these devices. However, employing these DRM techniques typically restricts the user's ability to playback the digital content on another user's device. This is problematic because users are accustomed to being able to loan their books, CDs, and DVDs to their friends, and these DRM techniques typically restrict the user's ability to loan digital media they've purchased to their friends.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects of the temporary domain membership for content sharing, a request is received for a first device to temporarily join a domain, the request having been digitally signed by a second device that is a member of the domain. A check is made as to whether the request is valid. If the request is not valid then the request is denied. However, if the request is valid, then a temporary domain certificate is generated for the first device, the temporary domain certificate allowing the first device to temporarily join the domain, and is sent to the first device.

In accordance with one or more aspects of the temporary domain membership for content sharing, at a first device both a digital certificate of a second device and a request for a digitally signed temporary domain join request are received from the second device. A check is made as to whether the digital certificate has been revoked, and whether a user of the first device has approved allowing the second device to temporarily join a domain of which the first device is a member. If the digital certificate has not been revoked and the user of the first device has approved allowing the second device to temporarily join the domain, then a temporary domain join request that includes a public key of the second device is created and digitally signed, and the digitally signed temporary domain join request is sent to a recipient. However, if the digital certificate has been revoked or the user of the first device has not approved allowing the second device to temporarily join the domain, then the request for the digitally signed temporary domain join request is denied.

In accordance with one or more aspects of the temporary domain membership for content sharing a first device sends, to a second device, a digital certificate of the first device for the second device to generate a digitally signed temporary domain join request on behalf of the first device. The first device receives, from a domain controller managing a domain of which the second device is a member, a temporary domain certificate allowing the first device to temporarily join the domain.

### BRIEF DESCRIPTION OF THE DRAWINGS

The same numbers are used throughout the drawings to reference like features.

FIG. 1 illustrates an example system in which the temporary domain membership for content sharing can be employed in accordance with one or more embodiments.

FIG. 2 illustrates a more detailed example system implementing the temporary domain membership for content sharing in accordance with one or more embodiments.

FIG. 3 illustrates an example temporary domain certificate in accordance with one or more embodiments.

FIG. 4 is a flowchart illustrating an example process for temporary domain membership for content sharing in accordance with one or more embodiments.

FIG. 5 is a flowchart illustrating another example process for temporary domain membership for content sharing in accordance with one or more embodiments.

FIG. 6 is a flowchart illustrating another example process for temporary domain membership for content sharing in accordance with one or more embodiments.

FIG. 7 illustrates an example computing device that can be configured to implement the temporary domain membership for content sharing in accordance with one or more embodiments.

### DETAILED DESCRIPTION

Temporary domain membership for content sharing is discussed herein. A temporary domain membership can be requested for a first device that is not a member of a particular domain. A second device that is a member of the particular domain digitally signs a temporary domain join request on behalf of the first device, and this request is sent to a domain controller for the particular domain. The domain controller issues, to the first device, a temporary domain certificate that allows the first device to temporarily join that particular domain.

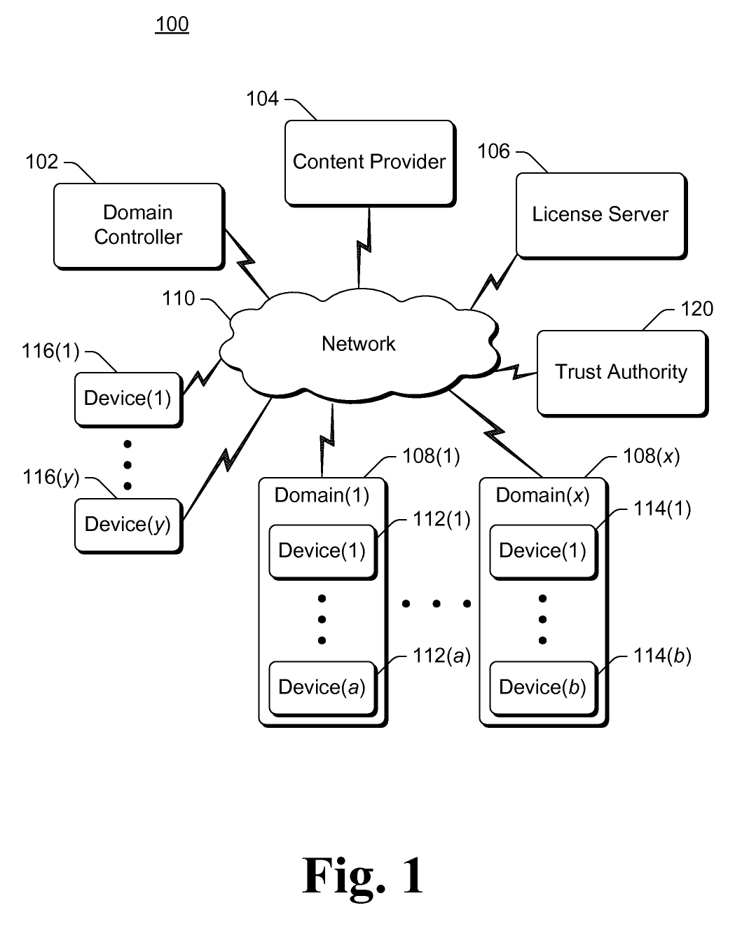

FIG. 1 illustrates an example system 100 in which the temporary domain membership for content sharing can be employed in accordance with one or more embodiments. System 100 includes a domain controller 102, a content provider 104, a license server 106, one or more (x) domains 108(1), . . . , 108(x), one or more (y) devices 110(1), . . . , 110(y), and a trust authority 120. Although only one domain controller 102, content provider 104, license server 106, and trust authority 120 are illustrated, it is to be appreciated that multiple ones of components 102, 104, 106, and 120 can be included in system 100.

Each of domain controller 102, content provider 104, license server 106, and trust authority 120 represents a service that can be implemented on one or more computing devices. Two or more of these services can optionally be implemented on a same computing device. Additionally, one or more of domain controller 102, content provider 104, license server 106, and trust authority 120 can be combined into a single service, or alternatively each can be a separate service.

Each of these components 102, 104, 106, 108, 110, 116, and 120 can communicate with one another over network 110. Network 110 can include one or more of a variety of networks, such as the Internet, a local area network, a cellular or other wireless phone network, other public and/or proprietary networks, combinations thereof, and so forth.

Each domain 108 includes one or more devices, illustrated as devices 112(1), . . . , 112(a) and 114(1), . . . , 114(b). Each of these devices 112, 114 that is included in a domain is also referred to as being a member of that domain. Additionally, one or more digital media devices 116(1), . . . , 116(y) may not be part of any domain 108. Devices 112, 114, and 116 can each be a variety of different types of digital media devices, such as desktop computers, laptop computers, handheld computers or personal digital assistants (PDAs), automotive computers, portable music players, portable movie players, cell or other wireless phones, and so forth. Different devices 112, 114, and 116 can be the same, or alternatively different, types of digital media devices.

Each of devices 112, 114, and 116 is a digital media device capable of consuming digital content. Digital content as used herein refers to a variety of different digital or electronic content, such as audio content (e.g., songs), audio/video content (e.g., television shows, movies, documentaries, cartoons, etc.), image content (e.g., digital pictures), graphics content, text content (e.g., electronic books), compiled or uncompiled computer programs or portions thereof, Java games, zipped or otherwise compressed files, email messages and attachments, and so forth, as well as combinations thereof. Consumption of digital content can take different forms, such as playback of the digital content, transferring the digital content to another device, burning the digital content to a CD (compact disc) or other optical disc, printing a hard copy of the digital content, emailing the digital content, and so forth.

Each domain 108 is associated with a particular user or group of users. Digital content is associated with (also referred to as bound to) the user's domain, allowing any of the devices 112, 114 that are part of that user's domain to consume the digital content that is bound to his or her domain. The different devices 112, 114 in a particular domain 108 can be different types of digital media devices, or alternatively one or more of devices 112, 114 can be the same type of device. For example, a user may have his or her desktop computer, portable music player, cell phone, and automotive computer all part of his or her domain, and all of these devices can consume digital content that is bound to his or her domain. A particular device 112, 114 can be a member of one or more domains 108. Furthermore, it should be noted that the devices 112, 114 within a domain 108 need not be aware of the other devices 112, 114 that are within that same domain.

For devices 116 that are not part of a domain, digital content is associated with (or bound to) that particular device 116. Device 116 is able to consume the digital content that is bound to device 116.

Domain controller 102 manages the domains 108. Management of a domain refers to controlling membership in the domain and imposing restrictions on members of the domain, including adding devices to the domain, removing devices from the domain, generating and distributing domain membership certificates, generating and distributing temporary domain certificates, and so forth. When a device 112, 114 joins a domain, the device 112, 114 is given a domain membership certificate for that domain from domain controller 102. This domain membership certificate, along with a content license, allows the device to consume protected content that has been bound to that domain, as discussed in more detail below. A device 112, 114, and/or 116 can also temporarily join a domain, in which case the device 112, 114, 116 is given a temporary domain certificate for that domain from domain controller 102. This temporary domain certificate, along with a content license, allows the device to temporarily consume content that has been bound to that domain, as discussed in more detail below.

Content provider 104 provides content to devices 112, 114, and 116. The content provided to devices 112, 114, and 116 are typically protected content. The protected content is protected through encryption, with decryption keys being included in content licenses associated with the protected content. Each content license is bound to a particular domain 108 or a particular device 116, so only those devices that are part of the particular domain 108 to which the content license is bound, or the particular device to which the content license is bound, can consume the content as discussed in more detail below.

License server 106 provides content licenses to devices 112, 114, and 116. Content obtained by devices 112, 114, and 116 from content provider 104 is protected. The devices 112, 114, and 116 access license server 106 to obtain a content license for the protected content. The content license can be bound to a particular domain or device.

Trust authority 120 digitally signs and issues digital certificates. Trust authority 120 is an entity, typically a service implemented on one or more computing devices, that is trusted by domain controller 102, content provider 104, and license server 106. Trust authority 120 acts as a trusted third party that can issue digital certificates to devices 112, 114, 116 that attest to the authenticity of the devices 112, 114, 116. Trust authority 120 can also issue a certificate that allows another entity (such as a device manufacturer) to issue such digital certificates to devices 112, 114, 116 thereby delegating the digital certificate issuance to this other entity.

References are made herein to symmetric key cryptography, public key cryptography and public/private key pairs. Although such key cryptography is well-known to those skilled in the art, a brief overview of such cryptography is included here to assist the reader. In public key cryptography, an entity (such as a hardware or software component, a device, a domain, and so forth) has associated with it a public/private key pair. The public key can be made publicly available, but the entity keeps the private key a secret. Without the private key it is computationally very difficult to decrypt data that is encrypted using the public key. So, data can be encrypted by any entity with the public key and only decrypted by an entity with the corresponding private key. Additionally, a digital signature for data can be generated by using the data and the private key. Without the private key it is computationally very difficult to create a signature that can be verified using the public key. Any entity with the public key can use the public key to verify the digital signature by comparing a verification value obtained using the public key with the original data, and if the two are the same then be assured that no one has tampered with or altered the data that was digitally signed.

In symmetric key cryptography, on the other hand, a shared key is known by and kept secret by the two entities. Any entity having the shared key is typically able to decrypt data encrypted with that shared key. Without the shared key it is computationally very difficult to decrypt data that is encrypted with the shared key. So, if two entities both know the shared key, each can encrypt data that can be decrypted by the other, but other entities cannot decrypt the data if the other entities do not know the shared key.

Reference is also made herein to digital certificates. Digital certificates are well-known to those skilled in the art. Nonetheless, a brief overview of digital certificates is included here to assist the reader. A digital certificate can be generated by a trust authority that attests to the trustworthiness of a particular entity. The digital certificate typically includes a public key of the particular entity for which the digital certificate is being generated, and the digital certificate is digitally signed by a trust authority using a private key of the trust authority. If entity A desires to verify the trustworthiness of entity B, then entity A can obtain the public key of the trust authority (which in some embodiments can be entity A) and verify the digital signature of the entity B's digital certificate. As the trust authority is trusted by entity A, entity B can be verified as being trusted if the digital signature of entity B's digital certificate is verified as being correct.

Generally during operation of system 100, devices can communicate with domain controller 102 to join a particular domain 108. When joining a particular domain 108, domain controller 102 gives the device the ability to consume content bound to that domain 108. The devices in that domain 108 can obtain encrypted content from content provider 104 or other devices 112 (or 114) within that domain 108, and obtain a license corresponding to the content from license server 106. The license is bound to the particular domain 108 and typically includes a content key to decrypt the encrypted content. Devices that are members of that particular domain 108 are able to decrypt the content keys from licenses bound to that particular domain 108, and can in turn use the content key to decrypt the encrypted content. Such devices can then consume the content in accordance with the policies included in the license. Devices that are not bound to that particular domain 108 are not able to decrypt the content keys from the licenses bound to that particular domain 108, and thus are not able to decrypt the encrypted content.

However, under certain circumstances a device that is not a member of that particular domain 108 can obtain a temporary domain membership for that particular domain 108. To obtain a temporary domain membership for a particular domain 108, a member of that particular domain 108 digitally signs a temporary domain join request on behalf of the device, the temporary domain join request including a digital certificate of the device. Domain controller 102 receives the temporary domain join request and determines whether to issue the temporary domain membership. In situations where domain controller 102 decides to issue the temporary domain membership, domain controller 102 issues a temporary domain certificate for the device. The temporary domain certificate allows the device to temporarily join the particular domain 108, allowing the device to temporarily consume content bound to the particular domain 108 as if the device were a member of the domain. However, this consumption of the content can be restricted based on the license corresponding to the content and/or other restrictions (e.g., restrictions included in the temporary domain certificate). Such restrictions typically include an amount of time for which the temporary domain membership is valid, which is typically a shorter amount of time than non-temporary domain membership would be.

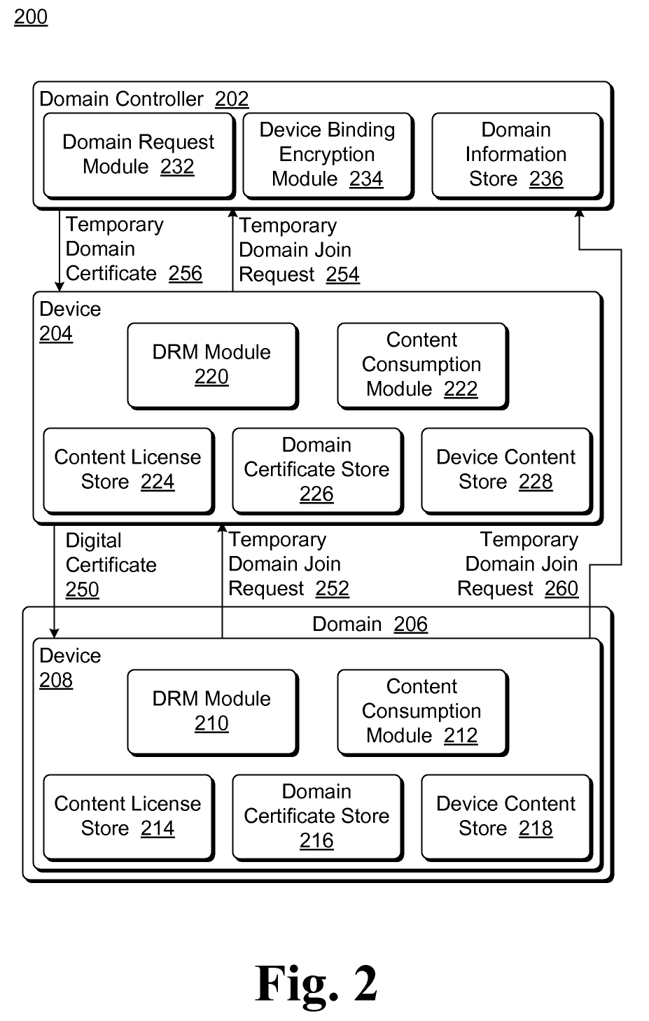

FIG. 2 illustrates a more detailed example system 200 implementing the temporary domain membership for content sharing in accordance with one or more embodiments. FIG. 2 illustrates a domain controller 202, a device 204, and a domain 206, which can be, for example, a domain controller 102, a device 116, and a domain 108 of FIG. 1, respectively. Communication among these components 202, 204, and 206 can be carried out over a network such as network 110 of FIG. 1.

Domain 206 is illustrated as having a member device 208. Although a single device 208 is illustrated as being a member of domain 206 for ease of explanation, it is to be appreciated that domain 206 can include two or more devices 208. Device 208 includes a digital rights management (DRM) module 210, a content consumption module 212, a content license store 214, a domain certificate store 216, and a device content store 218. Although illustrated as being separate, one or more of module 210, module 212, store 214, store 216, and store 218 can alternatively be combined.

DRM module 210 implements the digital rights management techniques for device 208. Digital rights management refers to the protection of the rights of the artists, publishers, and/or copyright owners of digital content. Restrictions on the use of content included in content licenses and/or certificates of domains or devices are enforced by DRM module 210. Generally, DRM can employ various techniques for restricting the consumption of content, such as conditional access, copy protection, content protection, and so forth. The specific manner in which these techniques are implemented can vary by DRM system.

Digital content is typically protected by being encrypted so that the content can only be played back in an intelligible manner if the proper decryption key(s) is known. DRM module 210 can employ various DRM techniques to determine when it is permissible to decrypt the content, and these DRM techniques can be implemented in a variety of different manners. For example, the DRM techniques can include verification that the operating system and/or other software executing on device 208 is trustworthy, verification that the constraints dictated by the owner of the copyright of the content and/or the distributor of the content have been satisfied, verification that a domain membership certificate is valid (e.g., not expired), and so forth. Various different DRM techniques are known to those skilled in the art, and any such techniques can be used by DRM module 210.

Device content store 218 stores content that is obtained from a content provider, such as content provider 104 of FIG. 1. The content provider is typically a remote device or service from which protected (e.g., encrypted) content can be obtained. Alternatively, the content provider can be another local device (e.g., another device 112, 114, or 116 of FIG. 1), a local media device (e.g., a compact disc (CD) or digital versatile disc (DVD)), and so forth. Device content store 218 is typically implemented as part of device 208, although all or a portion of device content store 218 may alternatively be implemented on a separate device. Additionally, device content store 218 can be implemented at least in part on removable media, such as a Flash memory card, a portable hard drive, and so forth.

Content license store 214 stores content licenses corresponding to protected content in content store 218. Licenses can be obtained from a license server, such as license server 106 of FIG. 1, or alternatively another service or device (e.g., a device 112, 114, or 116 of FIG. 1). The content license binds particular content to domain 206 by allowing only members of domain 206 to decrypt the content. In one or more embodiments, this binding is achieved by encrypting a content key for the content (e.g., a symmetric key) with the public key of domain 206, and including the encrypted content key in the license. As members of domain 206 have knowledge of the private key of domain 206, these members can decrypt the content key and thus can also decrypt the content. Alternatively, this binding can be achieved in other manners, such as encrypting the content key with a symmetric key of domain 206, encrypting the content key with a public key of device 208, and so forth.

Domain certificate store 216 stores domain certificates that have been issued to device 208. Domain certificates allow device 208 to access the information in content licenses and extract the appropriate information from the content licenses to allow device 208 to consume the associated content. Domain certificates in store 216 include, for example, a private key of domain 206 encrypted with a public key of device 208, or a private key of another domain (of which device 208 is a temporary member) encrypted with a public key of device 208. As device 208 has knowledge of the private key of device 208, device 208 can decrypt the private key of domain 206 in the certificate. Alternatively, this domain key can be a symmetric key.

Device 208 also includes a content consumption module 212. Content consumption module 212 accesses and consumes digital content on device 208, subject to DRM module 210. Content consumption module 212 can allow for various different kinds of consumption of the digital content, such as playback of the digital content, transferring the digital content to another device, burning the digital content to a CD or other optical disc, printing a hard copy of the digital content, emailing the digital content, and so forth. Content consumption module 212 can be a separate module as illustrated, or alternatively can be incorporated into another module (such as DRM module 210).

It should be noted that some of the content obtained by device 208 may not be protected content. For example, some freely-distributed content may be obtained by device 208, content may be copied to device 208 from a CD without any protection, and so forth. How such unprotected content is handled is determined by content consumption module 212 without needing to involve DRM module 210.

Device 204 is illustrated as not being a member of domain 206. Device 204 can be a separate device that is not a member of any domain, or alternatively can be a member of one or more domains (other than domain 206). Device 204 includes a DRM module 220 that operates analogous to DRM module 210 of device 208, and a content consumption module 222 that operates analogous to content consumption module 212 of device 208. Similarly, device 204 includes a content license store 224 that operates analogous to content license store 214 of device 208, a domain certificate store 226 that operates analogous to domain certificate store 216 of device 208, and a device content store 228 that operates analogous to device content store 218 of device 208.

Domain controller 102 includes a domain request module 232, a device binding encryption module 234, and a domain information store 236. Module 232, module 234, and store 236 can be implemented on the same device, or alternatively can be implemented on multiple devices.

Domain request module 232 manages domain 206, controlling which devices are allowed to join domain 206. This management includes controlling whether devices can temporarily join domain 206. Domain request module 232 can allow devices to join, or prevent devices from joining, domain 206 based on a variety of different criteria. Examples of such criteria include restrictions on how many devices can join domain 206, restrictions on what types of devices (e.g., DRM modules 210 on the devices) can join domain 206, user credentials that are to be supplied by a user of a device to join domain 206, and so forth. Domain request module 232 can allow a device to temporarily join domain 206 based on one or more of the same or different criteria, such as restrictions on how many devices can temporarily join domain 206, restrictions on what types of devices (e.g., DRM modules 220 on the devices) can temporarily join domain 206, whether a digital certificate of a device has been digitally signed by a member of domain 206, and so forth.

Domain information store 236 stores information regarding various domains managed by domain controller 202. This domain information can include information used by domain request module 232 in determining whether to allow devices to join domain 206 (whether temporarily or non-temporarily), such as information describing limits as to how many devices can be part of domain, information describing limits as to how frequently a user can add devices to a domain, and so forth. This domain information can also include device IDs for each device that is a member of domain 206, rights associated with domain 206, a public/private key pair of domain 206, public keys of devices that are members of domain 206, and so forth.

Device binding encryption module 234 generates domain certificates binding licenses (and thus content, as discussed above) to domain 206. Domain certificates can bind licenses to domain 206 in different manners. In one or more embodiments, this binding is achieved by generating a domain certificate including at least a portion (e.g., a private key of domain 206) encrypted with a public key of device 208. Alternatively, this binding can be achieved in other manners, such as by generating a domain certificate including at least a portion (e.g., a private key of domain 206) encrypted with a key and securely issuing this key to the device in the domain, by employing a secure key exchange protocol to establish a symmetric key between domain controller 202 and a device in domain 206 and generating a domain certificate including at least a portion (e.g., a private key of domain 206) encrypted with the symmetric key, and so forth.

Temporary domain membership is useful in many different scenarios where a user desires to have a device temporarily join his or her domain. For example, a user may be visiting a friend's house where they decide they want to watch a movie that is on the user's portable device. The friend has a movie playback device, but that device is not a member of the same domain as the user's portable device. So, using the temporary domain membership for content sharing discussed herein, the friend's device can be given a temporary domain certificate giving the friend's device temporary membership in the user's domain. The content from the user's portable device can then be played back by the friend's device, allowing the user to share the content with his or her friend.

In system 200, device 204 is not a member of domain 206, but device 204 can be given a temporary domain certificate allowing device 204 to temporarily join domain 206. To obtain this temporary domain certificate, device 204 sends a digital certificate 250 of device 204 to a device in domain 206, such as device 208. Digital certificate 250 of device 204 can be a digital certificate specific to device 204, or a digital certificate specific to another domain (other than domain 206) of which device 204 is a member.

The sending of digital certificate 250 can be initiated by device 204, or alternatively by device 208. For example, device 204 can request that device 204 be allowed to temporarily join domain 206, or device 208 can request that device 204 be allowed to temporarily join domain 206. Such a request can be initiated by a user of one of devices 204 or 208, or alternatively can be automatically generated by a module or component of one of devices 204 or 208.

Upon receipt of digital certificate 250, DRM module 210 determines whether to generate a temporary domain join request on behalf of device 204. Various different criteria can be used in determining whether to generate the temporary domain join request. In one or more embodiments, DRM module 210 checks whether digital certificate 250 is valid. In such embodiments, device 208 maintains, or has access to, a list or other record of revoked digital certificates. DRM module 210 checks whether digital certificate 250 is on this list and thus has been revoked. If digital certificate 250 has been revoked then DRM module 210 does not generate the temporary domain request; otherwise DRM module 210 can generate the temporary domain request (optionally subject to other criteria being satisfied).

In one or more other embodiments, DRM module 210 checks whether a user of device 208 approves of device 204 temporarily joining domain 206. This check can be performed in addition to, or in place of, the check whether digital certificate 250 is valid. This check of whether the user of device 208 approves of device 204 temporarily joining domain 206 can be performed in different manners, such as displaying a prompt on a user interface (UI) of device 208 requesting the user to input approval or denial of device 204 temporarily joining domain 206. Alternatively, the check can be performed in other manners, such as the user having previously set one or more preferences or options on device 208 identifying one or more other devices (or users) that are approved to temporarily join domain 206. In other alternatives, the user of device 208 inherently approves of device 204 temporarily joining domain 206 by requesting digital certificate 250 from device 204.

If DRM module 210 determines not to generate a temporary domain join request on behalf of device 204, then a temporary domain join request is not generated and device 204 is optionally informed of this determination. However, if DRM module 210 determines to generate a temporary domain join request on behalf of device 204, then DRM module 210 generates the temporary domain join request including digital certificate 250. DRM module 210 also digitally signs the temporary domain join request, allowing domain controller 202 to verify that the request was generated by a member of domain 206 as discussed in more detail below. DRM module 210 can digitally sign the entire temporary domain join request, or alternatively only a part of the request (e.g., at least digital certificate 250). DRM module 210 can digitally sign the temporary domain join request (or portion thereof) using a private key, such as a private key of device 208, a private key of DRM module 210, a private key of domain 206, and so forth.

Alternatively, only a portion of digital certificate 250 is included in the digitally signed temporary domain join request. For example, a public key of device 204 (such as a public key specific to device 204 or specific to a domain of which device 204 is a member) could be extracted from digital certificate 250 and included in the digitally signed temporary domain join request without the remainder of digital certificate 250. Alternatively, other keys or mechanisms associated with device 204 (or a domain of which device 204 is a member) that can be used to bind a certificate to device 204 (or to a domain of which device 204 is a member) can be included in the digitally signed temporary domain join request in place of digital certificate 250.

In one or more embodiments, the digitally signed temporary domain join request is temporary domain join request 252. Request 252 is returned to device 204, which in turn sends the request to domain controller 202 as temporary domain join request 254. In one or more other embodiments, the digitally signed temporary domain join request is temporary domain join request 260, which DRM module 210 sends to domain controller 202. Thus, the digitally signed temporary domain join request can be communicated to domain controller 202 in different manners, such as via device 204, directly from device 208, and so forth.

Domain controller 202 receives temporary domain join requests, such as request 254 or request 260, and domain request module 232 determines whether to issue a temporary domain certificate 256 in response to the request. Domain request module 232 can determine whether to issue temporary domain certificate 256 based on one or more different criteria, such as restrictions on how many devices can temporarily join domain 206, restrictions on what types of devices (e.g., DRM modules 220 on the devices) can temporarily join domain 206, and so forth. These restrictions can be established by, for example, an administrator or other user of domain controller 202 and maintained in domain information store 236.

In one or more embodiments, domain controller 202 is restricted to allowing no more than a threshold number of non-expired temporary domain certificates to be issued at any one time. Accordingly, a temporary domain join request received after the threshold number of non-expired temporary domain certificates have been issued would be denied by domain request module 232. Once one or more of the temporary domain certificates that have been issued expire, then the temporary domain join requests would no longer be denied on that basis.

In one or more embodiments, the domain for which temporary domain membership is being requested is the domain of which the device that digitally signs the temporary domain join request is a member. This domain member can be identified, for example, by data included in the temporary domain join request, by data in domain information store 236, and so forth.

In embodiments in which the temporary domain join request identifies a domain for which temporary domain membership is being requested, domain request module 232 checks whether the temporary domain join request, or at least digital certificate 250 included in the temporary domain join request, has been digitally signed by a member of the requested domain. The digital signature is typically accompanied by a digital certificate or other data identifying the entity generating the digital signature. As identifiers of the members of domain 206 are maintained in domain information store 236, the request being digitally signed by a member of domain 206 can be readily confirmed.

If the digital signature cannot be verified (or the digital signature was generated by a device that is not a member of domain 206) then domain request module 232 denies the temporary domain join request and does not generate temporary domain certificate 256. An indication of this denial can optionally be returned to the source of the temporary domain join request. However, if the digital signature is verified and was generated by a device that is a member of domain 206, then domain request module 232 generates temporary domain certificate 256 (optionally subject to other criteria being satisfied).

Additionally, in one or more embodiments domain request module 232 checks whether digital certificate 250, which is included in the received temporary domain join request, is valid. This check can be in addition to, or in place of, such a check performed by DRM module 210 as discussed above. In such embodiments, domain controller 202 maintains, or has access to, a list or other record of revoked digital certificates. Domain request module 232 checks whether digital certificate 250 is on this list and thus has been revoked. If digital certificate 250 has been revoked then domain request module 232 denies the temporary domain join request; otherwise domain request module 232 generates temporary domain certificate 256 (optionally subject to other criteria being satisfied).

If domain request module 232 determines to issue a temporary domain certificate 256 in response to the temporary domain join request, then device binding encryption module 234 generates the temporary domain certificate 256. Device binding encryption module 234 binds the temporary domain certificate 256 to device 204, or alternatively to a domain of which device 204 is a member. As discussed above, the digitally signed temporary domain join request generated by device 208 includes a public key of device 204 or other key or mechanism associated with device 204 (or a domain of which device 204 is a member). The key or other mechanism included in the digitally signed temporary domain join request is used by device binding encryption module 234 to bind temporary domain certificate 256 to device 204 (or to a domain of which device 204 is a member).

In one or more embodiments, encryption module 234 binds temporary domain certificate 256 to a device and/or domain using the digital certificate 250 as included in the temporary domain join request received by domain controller 202. The digital certificate 250 as included in the temporary domain join request received by domain controller 202 includes a public key of device 204 (a public key specific to device 204 or a domain of which device 204 is a member). Temporary domain certificate 256 includes a private key of domain 206, and at least this private key of domain 206 is encrypted using the public key of device 204. Additional parts of temporary domain certificate 256 can also be encrypted using the public key of device 204.

Device 204 receives temporary domain certificate 256 and stores temporary domain certificate 256 in domain certificate store 226. Temporary domain certificate 256 is bound to device 204 (or a domain of which device 204 is a member), thereby allowing device 204 to use a private key of device 204 (e.g., a private key specific to device 204 or specific to a domain of which device 204 is a member) to decrypt the private key of domain 206 and thus consume content bound to domain 206.

Alternatively, domain controller 202 can communicate the private key of domain 206 to device 204 in other manners rather than including the private key in temporary domain certificate 256. By way of example, the private key of domain 206 can be bound to device 204 (or a domain of which device 204 is a member) and sent to device 204 separately from temporary domain certificate 256. This binding can be accomplished in a variety of different manners, such as encrypting the private key of domain 206 with a public key of device 204 (or a domain of which device 204 is a member), by employing a secure key exchange protocol to establish a symmetric key between domain controller 202 and device 204 and encrypting the private key of domain 206 with the symmetric key, and so forth.

In one or more embodiments, the temporary domain membership for content sharing discussed herein places no restrictions on proximity between device 204 and device 208. For example, devices 204 and 208 can be located in the same room, in different cities, in different countries, etc. Alternatively, in one or more embodiments a proximity restriction can be enforced. For example, one criteria employed by DRM module 210 in determining whether to digitally sign certificate 250 is that device 204 be within a threshold proximity of device 208. By way of another example, one criteria employed by domain request module 232 in determining whether to issue temporary domain certificate 256 is that device 204 be within a threshold proximity of device 208.

The proximity of devices 204 and 208 to one another can be identified in different manners. In one or more embodiments, geographic locations of devices 204 and 208 are identified and used to determine proximity. These geographic locations can be identified in different manners, such as based on zip codes where devices 204 and 208 are located (e.g., as identified by the users of the devices), based on phone numbers of devices 204 and 208 (e.g., as identified by the users of the devices), based on Global Positioning System (GPS) coordinates of devices 204 and 208 (e.g., as identified by GPS modules or components included in or coupled to the devices), based on a cell site or base station devices 204 and 208 are communicating with (e.g., as identified by a module or component in or coupled to the devices), and so forth. These geographic locations can be identified, a distance between the geographic locations of the devices calculated, and a check made as to whether this distance is below a threshold number.

Alternatively, the proximity of devices 204 and 208 can be identified in different manners. For example, devices 204 and 208 can be assumed to be within a threshold proximity of one another if they are communicating using particular protocols or techniques. As examples of such protocols and techniques, devices 204 and 208 can be assumed to be within a threshold proximity of one another if they are communicating with one another using an infrared (IR) connection, using a dedicated wired connection, using a Wireless Universal Serial Bus (Wireless USB) connection, via some other personal area network (PAN) communication protocol, and so forth.

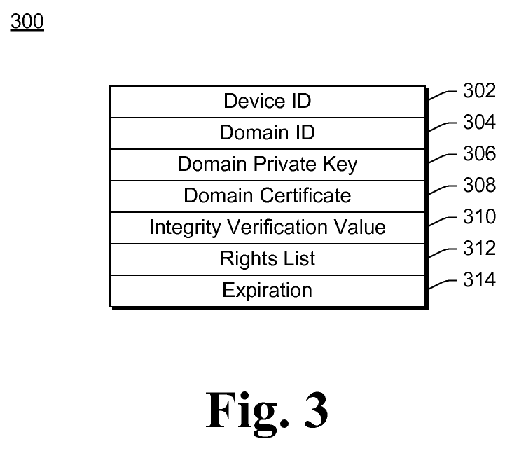

FIG. 3 illustrates an example temporary domain certificate 300 in accordance with one or more embodiments. Temporary domain certificate 300 can be, for example, temporary domain certificate 256 of FIG. 2. Temporary domain certificate 300 includes multiple fields or portions: a device ID 302, a domain ID 304, a domain private key 306, a domain certificate 308, an integrity verification value 310, a rights list 312, and an expiration 314. Temporary domain certificate 300 is bound to a particular device and/or a particular domain (e.g., device 204 of FIG. 2, and/or a domain of which device 204 is a member).

Device ID 302 is an identifier of the device to which temporary domain certificate 300 is bound (e.g., device 204 of FIG. 2), or alternatively of the domain to which temporary domain certificate 300 is bound (e.g., a domain of which device 204 of FIG. 2 is a member). This identifier can be received by the module or component generating temporary domain certificate 300 in response to a received temporary domain joint request. Domain ID 304 is an identifier of the domain that temporary domain certificate 300 for which temporary membership is being given (e.g., domain 206 of FIG. 2).

Domain private key 306 is the private key of a public/private key pair of the domain identified by domain ID 304. Each domain has its own public/private key pair, which can be stored, for example, in domain information store 236 of FIG. 2. The domain private key 306 is encrypted in temporary domain certificate 300. One or more other portions of temporary domain certificate can also optionally be encrypted.

Domain certificate 308 is a digital certificate associated with the domain identified by domain ID 304. This digital certificate can include various information describing the domain, such as the public key of the public/private key pair of the domain, and is digitally signed using the private key of domain controller 202 (e.g., by device binding encryption module 234 of FIG. 2). This digital signature allows another module or component to verify, if desired, that the certificate was actually generated by domain controller 202 and has not been tampered with.

Integrity verification value 310 is a value that can be used to verify the integrity of temporary domain certificate 300. This value can be generated in accordance with a variety of different verification techniques, such as a checksum over the portions (optionally except value 310) of temporary domain certificate 300, a digital signature over one or more portions (optionally except value 310) of temporary domain certificate 300, and so forth.

Rights list 312 is a set of rights and/or restrictions for the temporary domain membership being granted with temporary domain certificate 300. As discussed above, various restrictions on consumption of content can be imposed on members of a domain, and those restrictions can be identified in rights list 312. Additional restrictions can optionally be imposed on members being granted temporary domain membership, such as allowing playback but not copying or burning to a CD, allowing content to be played back or emailed only once, not permitting the device to generate a digitally signed temporary domain membership request on behalf of other devices for temporary membership in the domain, and so forth.

Alternatively, or in addition to rights list 312, other mechanisms can be used to establish rights and/or restrictions for the temporary domain membership being granted with temporary domain certificate 300. For example, such rights and/or restrictions can optionally be included in a DRM module of the device (e.g., DRM module 220 of FIG. 2).

Expiration 314 indicates an amount of time for which temporary domain certificate 300 can be used. Expiration 314 typically includes a date and/or time at which temporary domain certificate 300 expires and can no longer be used to extract information from content licenses in order to consume the associated content. Alternatively, temporary domain certificate 300 can have an associated issue date and/or time (included as part of temporary domain certificate 300 or alternatively maintained separately), and expiration 314 can be a duration indicating an amount of time after the issue date and/or time temporary domain certificate 300 during which certificate 300 can be used to extract information from content licenses in order to consume the associated content. While not expired, temporary domain certificate 300 can be used by a device (e.g., device 204 of FIG. 2) to decrypt a content key as discussed above. After expiring, temporary domain certificate cannot be used by a device to decrypt a content key (e.g., a DRM module of the device will recognize that temporary domain certificate 300 has expired and will not use certificate 300 to decrypt the content key).

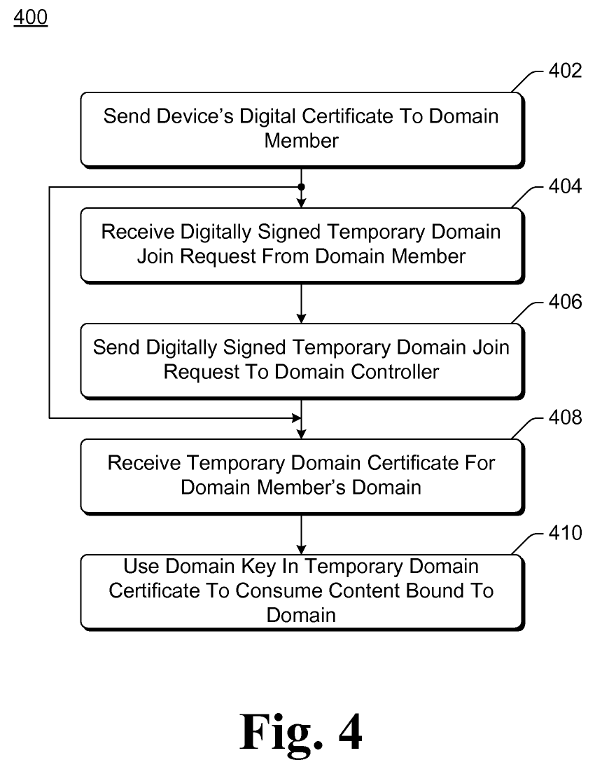

FIG. 4 is a flowchart illustrating an example process 400 for temporary domain membership for content sharing in accordance with one or more embodiments. Process 400 is carried out by a device seeking temporary membership in a domain, such as device 204 of FIG. 2, and can be implemented in software, firmware, hardware, or combinations thereof. Process 400 is an example process for temporary domain membership for content sharing; additional discussions of temporary domain membership for content sharing are included herein with reference to different figures.

Initially, a digital certificate of the device seeking temporary membership in a domain is sent to a member of the domain in which temporary membership is sought (act 402). As discussed above, this certificate can be a certificate specific to the device, or alternatively a certificate specific to a domain of which the device implementing process 400 is a member.

Sending of the certificate in act 402 can be initiated by the device implementing process 400, or alternatively in response to a request from the member of the domain to which the certificate is sent. By way of example, a UI can be displayed to a user of the device implementing process 400 allowing the user to input a request for temporary domain membership, from which the user can input a request for particular content on a device in the domain, and so forth. By way of another example, a UI can be displayed to a user of the device to which the certificate is sent allowing the user to input a request that the device implementing process 400 be given temporary domain membership, that particular content be transferred to the device implementing process 400, and so forth.

In one or more embodiments, after act 402 a digitally signed temporary domain join request is received from the domain member (act 404) and is sent to a domain controller (act 406) as discussed above. Alternatively, no such request may be received if the domain member determines not to generate a digitally signed temporary domain join request on behalf of the device implementing process 400, or if the digitally signed temporary domain join request is sent to the domain controller by the domain member as discussed above.

Regardless of the manner in which the digitally signed temporary domain join request is sent to the domain controller, after sending of the request a temporary domain certificate for the domain of which the domain member is a member is received (act 408). A domain key for this domain is included in the temporary domain certificate and is used to consume content bound to the domain member's domain (act 410). As discussed above, in one or more embodiments this domain key can be used to decrypt a content key in order to decrypt the content. This consumption can continue in accordance with the one or more licenses associated with the content until the temporary domain certificate expires.

It should be noted that the temporary domain certificate domain is received by the device implementing process 400 if the domain controller determines to issue a temporary domain certificate in response to the temporary domain join request. If the domain controller determines not to issue a temporary domain certificate in response to the temporary domain join request, then no such certificate is received in act 408 and used in act 410.

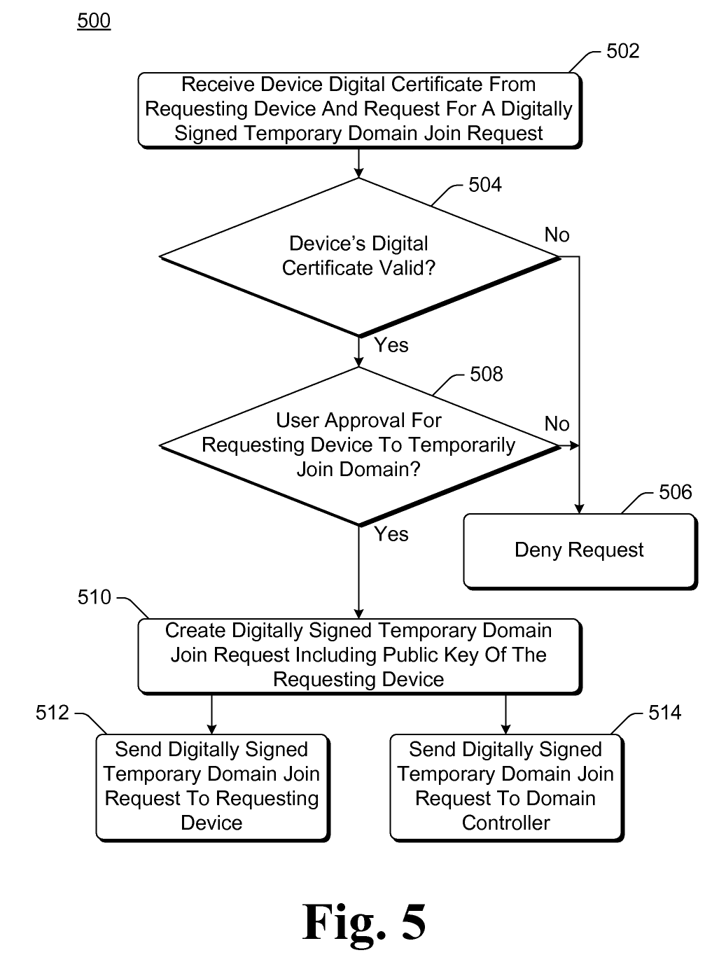

FIG. 5 is a flowchart illustrating an example process 500 for temporary domain membership for content sharing in accordance with one or more embodiments. Process 500 is carried out by a device that is a member of a domain, such as device 208 of FIG. 2, and can be implemented in software, firmware, hardware, or combinations thereof. Process 500 is an example process for temporary domain membership for content sharing; additional discussions of temporary domain membership for content sharing are included herein with reference to different figures.

Initially, a digital certificate of a device is received from a requesting device along with a request for a digitally signed temporary domain join request (act 502). The certificate and the request can be separate, or alternatively the request can be inherent. For example, the certificate can be received in response to a request for the certificate by the device implementing process 500, in which case the request for the digitally signed temporary domain join request can be inherent in the receipt of just the certificate. Additionally, as discussed above, the certificate for the requesting device can be specific to the requesting device or specific to a domain of which the requesting device is a member.

A check is then made as to whether the digital certificate of the requesting device received in act 502 is valid (act 504). This check for validity can be performed in different manners, such as checking a revocation list or record as discussed above. If the certificate received in act 502 were digitally signed, then this check for validity can also include verifying the digital signature of the certificate. Alternatively, act 504 may not be performed. As discussed above, the digital certificate of the device can be specific to the device or specific to a domain of which the device is a member.

If the digital certificate of the requesting device is not valid, then the request received in act 502 is denied (act 506). An indication of this denial can optionally be returned to the requesting device.

However, if the digital certificate of the device is valid, then a check is made as to whether the user of the device implementing process 500 approves the requesting device temporarily joining the domain (act 508). As discussed above, this determination of user approval can be performed in a variety of different manners. Alternatively, act 508 may not be performed.

If the user does not approve allowing the requesting device to temporarily join the domain, then the request received in act 502 is denied (act 506). An indication of this denial can optionally be returned to the requesting device.

However, if the user approves of the requesting device temporarily joining the domain, then a digitally signed temporary domain join request including a key of the requesting device is created (act 510). In one or more embodiments, this digitally signed temporary domain join request includes a public key of the requesting device (from the digital certificate received in act 502). The digitally signed temporary domain join request can include the certificate of the requesting device received in act 502 (which includes the public key of the requesting device), or alternatively some other key or mechanism to allow a temporary domain certificate to be bound to the requesting device.

The digitally signed temporary domain join request is sent to a recipient, such as a requesting device or a domain controller. In one or more embodiments, the digitally signed temporary domain join request is returned to the requesting device (act 512). Rather than sending the digitally signed temporary domain join request to the requesting device, or alternatively in addition to sending the digitally signed temporary domain join request to the requesting device, the digitally signed temporary domain join request is sent to a domain controller (act 514).

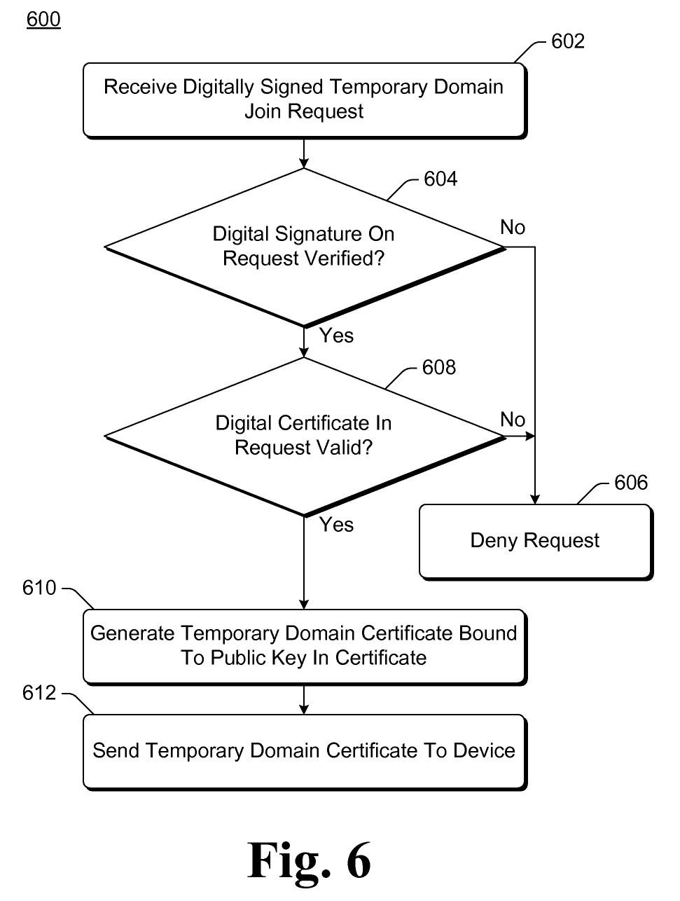

FIG. 6 is a flowchart illustrating an example process 600 for temporary domain membership for content sharing in accordance with one or more embodiments. Process 600 is carried out by a domain controller, such as domain controller 202 of FIG. 2, and can be implemented in software, firmware, hardware, or combinations thereof. Process 600 is an example process for temporary domain membership for content sharing; additional discussions of temporary domain membership for content sharing are included herein with reference to different figures.

Initially, a digitally signed temporary domain join request is received (act 602). A check is then made as to whether the digital signature on the temporary domain join request is valid (act 604). The digital signature on the temporary domain join request is valid if it can be verified. If the digital signature on the temporary domain join request is not valid, then the temporary domain join request is denied (act 606). An indication of this denial can optionally be returned to the device from which the request was received in act 602.

However, if the digital signature on the temporary domain join request is verified, then a check is made as to whether the certificate (or key or other mechanism) included in the temporary domain join request is valid (act 608). This check for validity can be performed in different manners, such as checking a revocation list or other record as discussed above. Alternatively, act 608 may not be performed (e.g., if a check for the validity were already performed by the device that digitally signed the temporary domain join request as discussed above).

If the certificate (or key or other mechanism) included in the temporary domain join request is not valid, then the temporary domain join request is denied (act 606). An indication of this denial can optionally be returned to the device from which the request was received in act 602.

However, if the certificate (or key or other mechanism) included in the temporary domain join request is valid, then a temporary domain certificate bound to a public key included in the certificate that is included in the temporary domain join request is generated (act 610). Optionally, as discussed above, one or more other criteria may also need to be satisfied in order for the temporary domain certificate to be generated. As discussed above, this temporary domain certificate can be bound to a specific device or to a specific domain. The generated temporary domain certificate is then sent to the device for which temporary domain membership is being requested (act 612). This temporary domain certificate is for the domain that the device that digitally signed the temporary domain join request is a member.

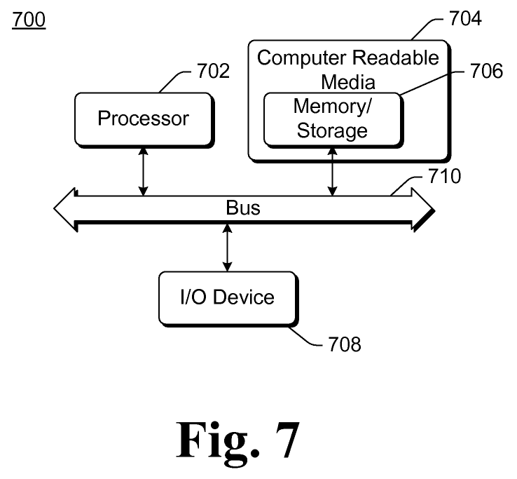

FIG. 7 illustrates an example computing device 700 that can be configured to implement the temporary domain membership for content sharing in accordance with one or more embodiments. Computing device 700 can be, for example, a device 112, 114, or 116 of FIG. 1, a device 204 or 208 of FIG. 2, or can implement at least a portion of a domain controller 102 of FIG. 1 or a domain controller 202 of FIG. 2, of a content provider 104 of FIG. 1, of a license server 106 of FIG. 1, or of a trust authority 120 of FIG. 1.

Computing device 700 includes one or more processors or processing units 702, one or more computer readable media 704 which can include one or more memory and/or storage components 706, one or more input/output (I/O) devices 708, and a bus 710 that allows the various components and devices to communicate with one another. Computer readable media 704 and/or one or more I/O devices 708 can be included as part of, or alternatively may be coupled to, computing device 700. Bus 710 represents one or more of several types of bus structures, including a memory bus or memory controller, a peripheral bus, an accelerated graphics port, a processor or local bus, and so forth using a variety of different bus architectures. Bus 710 can include wired and/or wireless buses.

Memory/storage component 706 represents one or more computer storage media. Component 706 can include volatile media (such as random access memory (RAM)) and/or nonvolatile media (such as read only memory (ROM), Flash memory, optical disks, magnetic disks, and so forth). Component 706 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 702. It is to be appreciated that different instructions can be stored in different components of computing device 700, such as in a processing unit 702, in various cache memories of a processing unit 702, in other cache memories of device 700 (not shown), on other computer readable media, and so forth. Additionally, it is to be appreciated that the location where instructions are stored in computing device 700 can change over time.

One or more input/output devices 708 allow a user to enter commands and information to computing device 700, and also allows information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The term “module” as used herein generally represent software, firmware, hardware, or combinations thereof. In the case of a software implementation, the module, functionality, or logic represents program code that performs specified tasks when executed on a processor (e.g., CPU or CPUs). The program code can be stored in one or more computer readable memory devices, further description of which may be found with reference to FIG. 7. The features of the temporary domain membership for content sharing techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for allowing temporary domain membership, the method comprising:
receiving a request for a first device to temporarily join a domain, the request having been digitally signed by a second device that is a member of the domain;
checking whether the request is valid;
if the request is not valid then denying the request; and
if the request is valid, then:
generating a temporary domain certificate for the first device, the temporary domain certificate allowing the first device to temporarily join the domain; and
sending the temporary domain certificate to the first device.

2. A method as recited in claim 1, wherein checking whether the request is valid comprises:
checking whether a certificate of the first device has been revoked;
verifying a digital signature from the second device having digitally signed the request;
determining that the request is valid if both the certificate of the first device has not been revoked and the digital signature is verified; and
determining that the request is not valid if one or both of the certificate of the first device has been revoked and the digital signature is not verified.

3. A method as recited in claim 1, wherein the temporary domain certificate is bound to a second domain of which the first device is a member.

4. A method as recited in claim 1, wherein the temporary domain certificate is bound to the first device.

5. A method as recited in claim 1, wherein the request includes a public key of a public/private key pair of the first device, and further comprising sending to the first device a domain private key of a public/private key pair of the domain encrypted with the public key of the first device.

6. A method as recited in claim 5, wherein the public key of the public/private key pair of the first device is included in a digital certificate that is included in the request, the digital certificate having been received by the second device from the first device.

7. A method as recited in claim 1, wherein the temporary domain certificate includes an expiration that defines a duration during which the first device is able to consume the content bound to the domain.

8. A method as recited in claim 1, wherein receiving the request comprises receiving the request from the first device.

9. A method as recited in claim 1, wherein receiving the request comprises receiving the request from the second device.

10. A method as recited in claim 1, further comprising:
checking one or more criteria on adding temporary devices to the domain; and
generating and sending the temporary domain certificate only if the one or more criteria are satisfied.

11. A method as recited in claim 10, wherein the one or more constraints include a restriction on how many non-expired temporary domain certificates can be issued at any one time.

12. One or more computer storage media having stored thereon multiple instructions that, when executed by one or more processors of a first device, cause the one or more processors to:
receive, from a second device, a digital certificate of the second device and a request for a digitally signed temporary domain join request;
check whether the digital certificate has been revoked;
check whether a user of the first device has approved allowing the second device to temporarily join a domain of which the first device is a member;
if the digital certificate has not been revoked and the user of the first device has approved allowing the second device to temporarily join the domain, then:
create and digitally sign a temporary domain join request that includes a public key of the second device; and
send the digitally signed temporary domain join request to a recipient; and
if the digital certificate has been revoked or the user of the first device has not approved allowing the second device to temporarily join the domain, then deny the request for the digitally signed temporary domain join request.

13. One or more computer storage media as recited in claim 12, wherein the digital certificate of the second device is a digital certificate specific to a second domain of which the second device is a member.

14. One or more computer storage media as recited in claim 12, wherein the digital certificate of the second device is a digital certificate specific to the second device.

15. One or more computer storage media as recited in claim 12, wherein the recipient comprises the second device.

16. One or more computer storage media as recited in claim 12, wherein the recipient comprises a domain controller managing the domain.

17. One or more computer storage media having stored thereon multiple instructions that, when executed by one or more processors of a first device, cause the one or more processors to:
send, to a second device, a digital certificate of the first device for the second device to generate a digitally signed temporary domain join request on behalf of the first device; and
receive, from a domain controller managing a domain of which the second device is a member, a temporary domain certificate allowing the first device to temporarily join the domain.

18. One or more computer storage media as recited in claim 17, wherein the instructions further cause the one or more processors to:
receive, in response to sending the digital certificate to the second device, the digitally signed temporary domain join request from the second device, the digitally signed temporary domain join request having been digitally signed by the second device;
send the digitally signed temporary domain join request to the domain controller; and
wherein the temporary domain certificate is received from the domain controller in response to the digitally signed temporary domain join request.

19. One or more computer storage media as recited in claim 18, wherein both the digital certificate of the first device and the digitally signed temporary domain join request include a public key of a public/private key pair of the first device, and wherein the instructions further cause the one or more processors to receive a domain private key of a public/private key pair of the domain, the domain private key being encrypted with the public key of the public/private key pair of the first device.

20. One or more computer storage media as recited in claim 17, wherein the digital certificate of the first device comprises a digital certificate of a second domain of which the first device is a member, the domain and the second domain being two different domains.
